(19) United States
(12) Patent Application Publication
(10) Pub. No.: US 2007/0219854 A1
(43) Pub. Date: Sep. 20, 2007

(54) Document Examiner Comment System

(75) Inventors: Raymond J. Mueller, Palm Beach Gardens, FL (US); Andrew S. Van Luchene, Santa Fe, NM (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: Leviathan Entertainment, LLC, Santa Fe, NM (US)

(21) Appl. No.: 11/697,486

(22) Filed: Apr. 6, 2007

Related U.S. Application Data
(63) Continuation-in-part of application No. 11/462,621, filed on Aug. 4, 2006.
(60) Provisional application No. 60/727,191, filed on Oct. 14, 2005.

(51) Int. Cl. H04M 3/51

(52) U.S. Cl. 705/11

(57) ABSTRACT

A system is described wherein interested entities are able to review opinions rendered by patent examiners and provide commentary on the opinion. The commentary may be stored with the opinion for review by other parties. Moreover, the commentary may be used to refine the types and number of applications that are given to the examiner for examination.

### CROSS REFERENCE TO RELATED APPLICATIONS

The present application is a continuation in part of U.S. patent application Ser. No. 11/462,621, “Fee-Based Priority Queuing for Insurance Claim Processing” filed Aug. 4, 2006, which claims the benefit of U.S. Provisional Patent Application No. 60/727,191, filed Oct. 14, 2005, each of which is hereby incorporated by reference.

### BACKGROUND OF THE INVENTION

Protecting intellectual property through patent systems is a vital part of most countries' national economies and well as the global economy. However, many patent systems are facing a number of challenges due to the increased technical complexity of patent applications as well as with the challenge of hiring and training new patent examiners to cope with the increasing number of applications being filed.

In 2000, 311,807 patent applications were filed in the U.S. This number increased to 409,532 applications in 2005. Globally, 145,300 applications were filed under the Patent Cooperation Treaty in 2006, representing a 6.4% growth over the previous year. This trend has held steady since 1995 with the number of applications filed increasing every year.

The problems in the protection of intellectual property rights are further compounded by virtual reality games. Hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. Many of these games purport to give intellectual property rights to the players in their virtual creations. However, these games lack a structured system for evaluating and granting such rights.

Given the increasing number of applications being filed and the increased demand for protection of intellectual property, it would be advantageous to provide alternate methods for assigning and distributing applications for examinations. Such alternate methods would relieve some of the pressure on patent systems, allowing examiner's to focus on the aspects of their duties that require human involvement.

### DETAILED DESCRIPTION

According to various embodiments, the present disclosure provides a document examiner comment system. According to one embodiment, a document is examined and an opinion is rendered by an examiner. End users can log into a system that permits partial or complete access to one or more of the documents and/or examiner opinions and gives the end user the option to submit a comment about the examiner or the examiner's rendered opinion. These comments are used to provide a rating for the examiner. The comments and ratings can be viewed or used by end users of a search engine database. The comments can be used to assign new documents to an examination queue.

According to various embodiments:

Advertisement—includes any communication via any medium to any one or more end users or any person or third party. Advertisements may include text, audio, video, icons, graphics, images, etc. Advertisements may include an offer for sale, for profit or not, and may or may not include a discount, for any services, products, financial instruments, e.g., insurance, annuities, securities, e.g., stocks, bonds, options, etc. and/or any other good or service, and/or may provide information about any of the forgoing or anything, such as a request for donations to political or charitable or any other entity or organization. Or, an advertisement might be used or designed to provide information to inform or educate any constituent and/or may include communications in support of any one or more objectives such as public relations, publicity, product placement or introduction, sponsorship, underwriting, public notice or service announcement or any other objective or purpose.

Alert—includes the transfer, delivery or storage of information or otherwise communicating with, by, between or among any two or more of the following, including, but not limited to any real or virtual: a) end user, b) game owners, c) game or other servers, d) player or player characters, e) NPC's, f) exchanges, g) game devices or controllers, h) cell phone or other communications hardware and/or networks, i) databases, j) software applications, k) legal agencies, l) governing bodies, m) software interfaces, n) any person, o) and/or any combination of any of the above, which may be initiated by and/or based upon an alert event or other action. Exemplary methods to determine alert events and/or to send alerts are disclosed for example, in U.S. patent application Ser. No. 11/676,848 “Virtual Environment with Alerts” filed Feb. 20, 2007 which is incorporated herein by reference.

Alert Event—includes any change in, of or to any condition or state, and includes any action, opposite action, unexpected action, desire for action, or failure to act, and thus Alert Event includes, but is not limited to any one or more of:
1. When or after any one or more variables or data changes or is expected or is about to change within an application, service, API, communications network or one or more databases, or database variables or element, e.g., a balance is reached or exceeded
2. When an end-user acts, e.g., clicks on a word or link, or fails to act as or when expected.
3. An amount of time elapses with or without an action.
4. When or after information is transmitted and/or shared (e.g. via a communications package or other mechanism) between two or more applications, services, servers, financial institutions, or any other entities, e.g., a message sent between two servers to provide information about one or more hyperlinks.

Approval Queue—includes a queue of documents and or prior art associated with those documents that is awaiting an approval mark from an entity such as a patent examiner

Boilerplate—includes any text, word, words, or phrases and/or part or all of a document which may be readily or otherwise reused with little or no modification and/or to serve as the basis of a new phrase or document, which use may save time and effort in the creation of said phrase or document. Boilerplate may include standard documents, terms, conditions, words, phases, etc., that can be incorporated or reused in multiple applications.

Blog—includes a user-generated website or other system where entries may be made in journal or other style and may be displayed in a reverse chronological or other order. Blogs often provide commentary or news on a particular subject, such as food, politics, or local news; some function as more personal online diaries. Blogs may include and/or combine or use text, images, and may include links, including hyperlinks to other blogs, web pages, documents, words, and other media related to its topic or subject matter. The term “blog” is derived from the term “Web log.” “Blog” can also be used as a verb, meaning to maintain or add content to a blog.

Certified Component—includes any piece of software that is a component of a total software solution that has been approved for use by an entity such as the USPTO

Certified Definition—includes the definition of a word or phrase as it relates to a class or subclass of patentable inventions that is approved by an central entity such as the USPTO

Certified Font—includes any font that is approved by a central entity such as the patent office for use in an invention disclosure or figures associated with such a disclosure.

Certified Icon—includes any icon that can be used in a figure to be submitted with a patent application to identify a standard component of invention that is approved for it use by a central entity.

Certified Plug-in—includes any software module that can be inserted into a larger software program and used to perform a sub function of the total function of the total system that is approved by a certification party such as the USPTO

Certified Shape—shall include any visual shape that can be used to identify a component in a patent or other drawing that is approved by a central entity such as the patent office for use in a figure associated with an invention disclosure

Certified Template—shall include a group of certified shapes, certified Icons, and or certified fonts that can be used in a figure associated with an invention disclosure and that is approved by a central entity such as the patent office.

Class, in the context of a patent application,—includes a class of patents or other digital documents in an electronic database

Click-through—includes the process of an end user selecting or otherwise activating a hyperlink

Document Map or Map—includes a visual representation of a group of documents or other items or objects, such as patents that shows the relationship of those documents, objects or items to one another. For example, a map might be of a group of documents and their relevancy to each other. Or, a map might include a visual representation.

End User—includes any person or entity, real or virtual that makes use of or otherwise practices any part or all of the disclosed invention and/or any software application or tool disclosed herein or otherwise. End users include, for example, patent applicants, patent examiners, patent attorneys, patent examiner supervisors, document review specialists, diagram or figure design engineers, survey respondents, search tool users, and other persons. In certain embodiments, an end user may be an application, application program interface, reporting or other tool or automated process.

Genetic Algorithm—includes any software application or module that can improve results with use.

Hyperlink or link—includes a set of instructions or code, which may be embedded, or otherwise associated with or connected to, an element, word, object, icon, document, figure, map, file attachment, or other displayed area within a document which, when selected, clicked or otherwise activated by an end user, may cause a computer to perform one or more functions. Examples of functions that might be performed include, but are not limited to, displaying new or additional information, redirecting to a different area of the same or a new document, displaying an advertisement, soliciting and/or capturing information, opening a form that requires end user input, and/or displaying new information that is generally associated with and/or related to the hyperlinked element. New or additional information and/or webpage(s) may or may not be displayed using a separate or new web browser page or popup window or interstitial. Hyperlinks are commonly identified through the use of an underline and/or color coding, e.g., HYPERLINK, but this is not necessarily required or desired. Hyperlinks may be activated by any applicable means, including, but not limited to, left or right clicking on or near the link, placing a pointer on or near the link (briefly, temporarily or not), touching the area, e.g., via use of a touch screen or other pointing mechanism, and/or automatically, e.g., based upon date or time, or other action or inaction of the end user. For example, in some situations, failure to respond within a given timeframe may cause execution or delay of execution of a hyperlink. A hyperlink may be associated with other hyperlinks, e.g., hyperlinks within hyperlinks, documents, programs, words, phrases, or other information or actions. For example, if an end user right clicks on a hyperlink, one or more options may appear, permitting the end user some degree of flexibility in the action or actions taken. The terms link and hyperlink shall have corollary meanings.

Information Disclosure Statement (IDS)—includes the definition provided by the United States Patent and Trademark Office (USPTO).

IDS Report—includes a document that references all prior art material associated with a patent application or invention disclosure

Image—includes figures, pictures, drawings, document images, e.g., document snapshots, etc.

Improvement Module—includes a sub module that is embedded in a total system that is used to improve upon the total system or other sub modules embedded in that system.

Keyword—includes any word or words that are identified as being “of interest.” A keyword may be of interest because it is a word that generally helps to describe the content of the document in which it is used, or for other reasons.

Lexicon—includes a group of words with corresponding definitions that is broken into classes and subclasses that are associated with the class and subclass of documents in a database such as the digital database of filed and or issued patents of the USPTO

Mapping—includes the process of associating documents to one another and providing a visual representation of the relationships of those documents.

Merchant—includes any person that desires to sell a good or service or desires to have one or more end users to review, select, or click a hyperlink in a document and/or receive other information and/or perform other tasks and/or receive information associated with one or more keywords selected by such merchant.

Notes—includes any computer file or data or any free form or other text, graphics, figures and/or any files such as any audio, video, e.g., JPEG or MPEG, pictures, e.g., GIF, or other files, such as, PDF, XLS, XML, TXT, DOC, RTF, or any other known files such as those described on the websites: http://filext.com/ and http://www.computeruser.com/resources/dictionary/filetypes.html, which are incorporated herein by reference. Notes may be attached or associated with any one or more of the following, any electronic element, word or words, phrase, document, figure, hyperlink, webpage, database, table, file, or any other electronic media. Notes may include any description, hyperlink, figure, document or file associated or attached to any of the forgoing and/or any combination of the forgoing. In certain embodiments, notes may contain or refer or reference other notes, e.g., notes within notes.

Patent Application—includes an invention disclosure that has been filed with a registration entity such as the USPTO

Patent Application Drafting Tool—includes a web based software program that assists in the drafting and filing of patent applications with a registration entity such as the USPTO. Exemplary methods to determine alert events and/or to send alerts are disclosed for example, in U.S. patent application Ser. No. 11/676,848 “Virtual Environment with Alerts” filed Feb. 20, 2007 which is incorporated herein by reference.

Patent Drafting Engine—includes a software module that can partially or completely draft and/or modify an existing draft patent application and/or file those applications with a registration entity such as the USPTO.

Patent Figure—includes any figure or document attached to a patent application

Patent Section—includes any section of a patent application or invention disclosure such as the background, summary, title, abstract and or claims.

Patentability Score—includes a score assigned by one or more people, e.g., an end user, or computer programs to a patent application that relate to its strength of patentability in categories such as novelty, obviousness, and usefulness.

Plug-in—includes any software application or module or one or more computer instructions, which may or may not be in communication with other software applications or modules, and may include any file, image, graphic, icon, audio, video or any other attachment. Plug-ins may be comprised of any one or more set of computer instructions using any computer programming language.

Relevancy—includes how relevant a word, phrase, patent section, patent figure or document is to another word, phrase, patent section, patent figure or document

Rules—includes computer instructions that can provide application direction and/or decision making and includes both inference and reactive rules. Rules may include permissions, limitations, method steps, alert event conditions, alert contents, workflow instructions, security measures, business process management instructions, if/then/else instructions and/or any supporting data, variables, or computing instructions and/or logic.

Rules Based—includes any system or application or module that uses or relies on one or more rules.

Search Relevancy—includes how relevant sections of a document are to a word, phrase, patent section, patent figure, or document are when producing search results for a query. For example, the abstract of a patent document can have higher search relevancy than the background of a patent document when conducting prior art searches using a prior art search software tool.

Search Weight—shall mean the score that one section of a document has to other sections of a document when conducting searches against a database of documents in which that document is included.

Subclass—includes a subclass of patent documents as defined by the USPTO. Subclass can also include any sub classification of a database of electronic documents.

Synonym—is any word or group of words that have the same or similar meaning of another word or group of words and/or that may be interchangeable. The opposite of synonym is antonym.

Thesaurus—includes an electronic database of words that have been mapped to indicate similarities in word definitions. The thesaurus may be broken into classes and subclasses that relate to the classes and subclasses of documents stored in an electronic database and/or accessed via such database

Virtual—includes anything that is not real, in whole or in part, and/or anything real, in whole or in part; which may be simulated, represented, presented or depicted in a virtual environment, video game or displayed on a screen.

Virtual Environment—any technology that permits one or more end users to interact with a real, imaginary or virtual computer simulated environment.

Virtual World—includes a world created in an online game such as World of Warcraft, or a virtual community such as Second Life, Eve or There.com

Video Game—shall mean any massive multi online player game such as World of Warcraft and any virtual world such as Second Life

Web page—includes any resource, form, or any information that is accessible via the Internet and that is suitable or exists on the world wide web. A web page usually includes information in any applicable format, e.g., HTML or XHTML. Web pages may include hyperlinks or provide other means of navigation to other web pages. Web pages may be accessed by any applicable means, including, but not limited to: any computing or internet enabled devices, e.g., personal computers, laptops, PDAs, cell phones, video game controllers, or any other communications device, which may be local or remote to the computer or server where such web page(s) may exist or reside.

Word—includes one or more groups of letters including titles, indices, text, headings, descriptions, diagrams, etc., and documents (in whole or in part), phrases (i.e., groups of two or more words), synonyms, antonyms, icons, graphics, drawings, schematics, blueprints, pictures, audio and/or video, and/or any combination of the forgoing, The words “Word” and “Words” shall have corollary meanings.

As stated above, according to various embodiments, the present disclosure provides a document examiner comment system. Such a comment system may be a separate application provided by a document examining authority, such as the USPTO or a third party. The system may or may not be integrated with the examining authority's software. In certain embodiments, the presently described system may be provided as an add-on module or plug-in to an existing system or application, for example, Google's search engine, or a Patent Application Drafting Tool (PDT) such as that described in U.S. patent application Ser. No. 11/627,263, which is hereby incorporated by reference. Accordingly, the system herein described may be added to the examining authority's existing applications or provided as a stand alone product offered by the examining authority or a third party.

According to an embodiment, the examiner commenting system described herein may be implemented through the creation of a notes system. Exemplary methods to provide attachment of notes into documents and/or associate notes with documents, or words, or other data are disclosed in U.S. patent application Ser. No. 11/690,095 “Facilitating Certified Prior Art Note Taking and Method for Using Same,” filed Mar. 22, 2007; ______ (Attorney docket No. 3307102) entitled “Note Overlay System,” filed Apr. 6, 2007; and ______ (Attorney docket No. 3307103) entitled “Document Examiner Comment System,” filed Apr. 6, 2007; each of which is incorporated herein by reference. When using a notes system, such system may be a part of a generic notes system, or it may be a separate notes system provided primarily for the purpose of providing examiner opinions and/or notes regarding such opinions. In certain embodiments, a generic notes system may be modified to add specific features, functions and design improvements in support of any one or more of the herein disclosed inventions and methods.

According to an embodiment, when an examiner renders and enters one or more opinions, such opinion(s) are recorded and entered into a database, for example, a notes database. When such opinion(s) are entered or recorded, one or more parties or end users may be notified, including any one or more or any combination of: the examiner's supervisor, the inventor(s), the assignee, the attorney of record, and/or any other third parties, including, for example, interested inventors, patent attorneys, and/or entities. For example, various parties may indicate fields of use, classes, subclasses, inventors, assignees, or any other category in which they have an interest and, when an opinion is rendered to an application that satisfies the indicated area of interest a copy of, or link to, the rendered opinion may be provided to or made available to the interested party. Interest may be indicated via overt means, e.g., though a process wherein the party requests to receive such notifications, and/or may be determined by any other suitable means, for example, by tracking third parties' searching activities. Notifications may be provided via any applicable means, including, for example an alert or email message. Exemplary methods to determine alert events and/or to send alerts are disclosed for example, in U.S. patent application Ser. No. 11/676,848 “Virtual Environment with Alerts” filed Feb. 20, 2007 which is incorporated herein by reference.

According to various embodiments, examiners may render and record opinions at any time and/or may be limited to specific or approved times at various steps throughout the examination process. Examiners may copy an opinion from one application, in whole or in part, to another related or otherwise relevant application or whenever such copying is desired or useful. A copy and paste option may save the examiner time and effort in rendering an opinion. Prior or subsequent to pasting a copied opinion, the examiner may be given the option of making changes to the copied opinion. The original source of the copies information may or may not be stored with the copied information or otherwise made identifiable and may or may not be made available to the end user, applicant, assignee, attorney of record, etc.

According to another embodiment, once an opinion has been recorded, end users may be notified, for example, via an alert. Furthermore, end users may be permitted to provide comments regarding the opinion. Comments can be provided by any one or more of the following, including:
1. Patent Examiners
2. Submitter of the original document
3. Submitter of subsequent documents
4. A certified commenter
5. Any other authorized end user.

A comment can include (if permitted/authorized/available):
1. A word, sentence, paragraph or longer text entry
2. A score, grade or ranking
3. A note
4. A hyperlink
5. A document, figure, or attachment
6. A copy of another opinion, prior opinions and/or commentary or notes from the examiner and/or other examiner's relating to the current or unrelated patent applications/opinions

Comments may be made via any suitable means, including, for example, via a blog or notes system.

Comments may or may not be reviewable by the patent examiner and/or a supervisor or other third parties. Such access may or may not require end user or other authorization/permission.

According to various embodiments, certain opinions and/or comments may be entered and flagged as public or private and/or may carry any applicable designation, which may generally grant and/or restrict access to certain users or classes of end users. For example, an inventor may choose to affix a comment that only the patent examiner can see or review and/or respond to. Alternatively or additionally, a particular comment may only be viewable by such patent examiner's supervisor, the inventor's patent attorney, other persons or end users designated by the inventor submitting such commentary, and/or any other party or combination thereof.

In certain embodiments, notes may also include priority or other attributes or designations. For example, a note may be flagged as being of high or low importance and/or relating to claims or prior art. Such classifications or flags may be limited to those options permitted or otherwise included by the owner/developer of the system, and/or may be flexible, including an option to permit the creation and maintenance of any number or type of such classes. In some embodiments, classes may include sub-classes.

In certain embodiments, feedback or scores or grades may be aggregated and made available for subsequent review by any one or more of: the patent examiner(s), supervisors, end users, inventors, patent attorneys, private companies or any third parties, perhaps only as authorized, and/or any combination of the forgoing. Such scores may be aggregated using any applicable means, for example, an average or a weighted average score may be determined. In the case of a weighted score, certain end user's votes or feedback or commentary may carry more or less weight than other end users. For example, the feedback or score provided by peers of the examiner may carry more weight than either the examiner's supervisor and/or the inventor.

In certain embodiments, a system to permit or support such calculations may include a table or rules based system, which permits authorized users to determine such relative rankings, and/or a self adapting or learning system may be implemented to provide a system which learns which scores should carry more or less weight. For example, a system based upon the use of one or more genetic algorithms may be implemented. By receiving feedback from large numbers of users, the system could determine, over time, which users and/or classes of users are more adept at providing such feedback or scores and/or which end users and/or classes of user's feedback is more or less accurate or useful.

Use and applications of rules based, expert systems and/or genetic algorithms are well known in the prior art and may be implemented using any applicable means. For example, methods to develop rules, expert systems and/or genetic algorithms are discussed and disclosed in various issued and pending patents and reference and other materials, including the following books entitled: “Genetic Algorithms in Search, Optimization, and Machine Learning”, by David E. Goldberg, and “An Introduction to Genetic Algorithms,” by Melanie Mitchell, and “Expert Systems: Design and Development,” by John Durkin,” and “Logical Foundations for Rule-Based Systems (Studies in Computational Intelligence),” by Antoni Ligeza, each of which are incorporated herein by reference.

According to another embodiment, inventors or other interested parties, e.g., patent attorneys, may make use of such ranking and/or grades in determining which field of use and/or examiner they desire to submit or change submission and/or priority for a given application, inventor or group or class of applications. Exemplary methods for priority queuing documents are disclosed for example in U.S. patent application Ser. Nos. 11/462,621 11/462,621, “Fee-Based Priority Queuing for Insurance Claim Processing,” filed Aug. 4, 2006; Ser. No. 11/611,024 “System and Method for Prioritizing Items in a Queue” filed Dec. 14, 2006; and PCT Application No. PCT/US06/340347, “Insurance Form Priority Queuing;” each of which are incorporated herein by reference.

A system such as that described herein may also be affected by a feedback mechanism that includes information regarding the eventual outcome or activities associated with any one or more such applications and/or examiners. For example, a system could be implemented that provides information about the ultimate issuance or rejection of one or more applications reviewed by one or more examiners. If a given examiner's cases are more frequently upheld in a court of law, then such examiner's opinions could be ranked higher than those of other, less successful examiners. Meanwhile, if one or more end user's scores for a given patent examiner or group of examiners turns out to be more or less accurate, i.e., does or does not serve as a good predictor of the eventual outcomes, then such end user's opinions or scores may carry a higher or lower weight as compared with other end users that have provided opinions or scores that have proven more or less accurate as predictors of such examiner(s)' performance. In this fashion, a system is disclosed that can determine which examiner's and/or end user's opinions are more or less valid and/or which should be weighted more or less heavily, in general and/or within fields of use or other classifications.

In certain embodiments, end users, e.g., inventors, examiners, examiners' supervisors and/or patent attorneys may use scores and opinions to determine which examination queue they prefer for a given patent application or group of applications. For example, using the scores and opinions provided by this disclosed invention, a patent attorney may determine that a new application would be best served by being examined by a particular examiner and/or within a specific examination queue. In addition or in the alternate, such attorney may further conclude that, since a similar or related application has been or is about to be examined within a given queue or by a particular examiner, that his client would best be served if his application is reviewed sooner rather than later, as relevant information and decisions are or have been recently made by a particular examiner and/or within particular queue. In such cases, an end user, e.g., inventor or patent attorney, may be in a position or otherwise desire to pay or request for a change in venue, examiner, and/or queue or queue position. Such changes and fees, if any, for such change requests may be made by any applicable means.

In another embodiment, whenever a comment, note or score or other information is provided regarding an examiner and/or an examiner's opinions or comments, such examiner and/or his supervisor or other applicable party may be notified of such entry via an alert, for example, via an email message.

In another embodiment, examiners' pay may be based in whole or in part upon feedback from end users and/or results outcomes, e.g., patents being upheld or overturned, whether in court or via any review processes. For example, examiners may receive a pay increase or bonus if their opinions are ranked highly and/or are upheld when such examiner's cases are tested in a court of law.

In an embodiment, when submitting an opinion or comment, end users may desire access to prior opinions and/or comments. Therefore, a system may include a user interface that permits access to any such historical data. Such access may or may not require authorization. Such data may or may not be encrypted in order to provide added levels of security for such information. For example, in the case where large groups of end users are accessing the USPTO's database, certain of its information may be encrypted and/or carry a higher level of encryption and/or other security measures, e.g., user id and/or passwords, to ensure system integrity and to maintain the confidence of certain information, including, for example, unpublished pending patents and/or private communications or opinions. When an end user is authorized or is otherwise permitted to access such opinions or comments, the user interface may assist or aid such an end user by providing a search tool to permit scanning or searching for relevant opinions or comments, and/or any other accessible information, e.g., examiner scores or rankings.

Search results may be determined and sorted or presented via any suitable means, including, for example, in order of relevancy to the patent examiner, patent applicant, patent attorney, assignee, date, time, or any other relevant discriminating characteristic and/or any combination of the forgoing.

In addition to the novel relevancy ranking methods disclosed herein, other methods to determine relevancy between and among documents and/or websites are well known within the prior art, including, for example, the methods discussed in the book entitled “Text Databases and Document Management: Theory and Practice, by Amita Goyal Chin, which is incorporated by reference.

According to another embodiment, search results may include a list of hyperlinks that permit the end user to click on to be redirected to any such additional information or results data. Such a search tool may be based upon existing search engines, such as Google, and/or using any applicable means, including, for example, use of a plug-in module to enhance an existing or new search engine. Exemplary methods for providing patent and prior art searches are disclosed in U.S. patent application Ser. No. 11/671,380, “Automated Patent Searches” filed Feb. 5, 2007; Ser. No. 11/693,555 “Providing Certified Patent Searches Conducted by Third Party Researchers” filed Mar. 29, 2007; and ______ (Attorney docket No. 3304103) entitled “Enhanced Patent Prior Art Search Engine,” filed Apr. 6, 2007; each of which is hereby incorporated by reference.

In addition to or instead of using relevancy scores or ranking methods to aid in searching or selecting opinions or comments, they system may provide end users with sort and/or other selection criteria, including, for example, filters which can sort and/or filter by any applicable means, including: a) date, b) time, c) examiner, d) end user, f) patent attorney, g) patent application or patent number(s), h) supervisor, i) opinion type, class, subclass, or number, j) prior art references, k) case id or number, l) note id, m) and/or any combination of the above and/or by alphabetical or numeric sorting of any of the above in ascending and/or descending order, n) and/or any other data or variables stored or available in the database or connected databases or systems.

In certain embodiments, search algorithms and/or search results may be refined through the use of survey or other questions presented to the end user or examiner using the search tool to find and/or view comments and/or opinions or other notes. Such surveys may be provided using any applicable means. Exemplary methods to provide for survey questions and gathering of data are disclosed by applicants in U.S. Patent Application No. 60/774,177, entitled “Survey Based Qualification of Keyword Searches,” Ser. No. 11/278,123, also entitled “Survey Based Qualification of Keyword Searches” Ser. No. 11/562,738 “Survey Based Qualification of Keyword Searches” and Ser. No. 11/608,150, entitled “Map and Inventory Based On-Line Purchases” which applications are incorporated herein by this reference.

According to various embodiments, any of the disclosed methods for searching and/or sorting opinions and notes and/or other information, may be included in an existing or new search engine. Methods to create or modify search engines are well known and understood within the prior art and by any person of ordinary skill. For example, methods to design and build a search engine are disclosed and discussed by the authors of the following books, including, for example “Understanding Search Engines: Mathematical Modeling and Text Retrieval (Software, Environments, Tools), Second Edition, by Michael W. Berry and Murray Browne, which is incorporated by reference. Methods to create WebPages, hyperlinks and hypertext are well known in the prior art and any person with ordinary skill in the art can design and create such hyperlinks. Methods to design and create hypertext and/or hyperlinks are discussed and disclosed by the authors of the following reference and other materials, including, for example: “Intelligent Hypertext: Advanced Techniques for the World Wide Web (Lecture Notes in Computer Science), by Charles Nicholas and James Mayfield,” “Information Architecture for the World Wide Web: Designing Large-Scale Web Sites [ILLUSTRATED], by Louis Rosenfeld (Author), Peter Morville,” Creating Web Pages with HTML Simplified, by Sherry Willard Kinkoph (Author),” “Master Visually Web Design (With CD-ROM) by Carrie F. Gatlin and Michael S. Toot,” and “Creating Internet Intelligence: Wild Computing, Distributed Digital Consciousness, and the Emerging Global Brain (IFSR International Series on Systems Science and Engineering), by Ben Goertzel.” All of which are incorporated by reference.

In certain embodiments, one or more fees may be charged to practice or use of one or more of the systems or methods disclosed herein. For example, applicants may be charged a fee for access to and/or searching or reviewing or commenting one or more of an examiner's notes, comments and/or opinions and/or to copy and/or paste or use such information and/or to contest any opinion, statements, comment, or the like.

In certain embodiments, the disclosed invention may be practiced in the real or virtual world. For example, a video game may include a virtual patent office. Exemplary methods and systems for providing protection of intellectual property in a virtual environment are disclosed, for example, in U.S. patent application Ser. No. 11/428,263, “Video Game Environment” filed Jun. 30, 2006; Ser. No. 11/620,563 “Copyright of Digital Works in a Virtual Environment,” filed Jan. 5, 2007; Ser. No. 11/689,977, “Digital Rights Management in a Virtual Environment,” filed Mar. 22, 2007; Ser. No. 11/671,373 “Video Game with Control of Quantities of Raw Materials” filed Feb. 5, 2007; Ser. No. 11/680,960 “System for the Creation and Registration of Ideas and Concepts in a Virtual Environment,” filed Mar. 1, 2007; each of which is incorporated herein by reference. Accordingly, the disclosed invention may be applied to a suitable virtual environment, world or video game(s). For example, commentary and opinions and/or scoring, such as those disclosed herein may be created, used and/or delivered in the virtual world. For example, virtual patent examiners (which may or may not be real world patent examiners too), may be used to provide patent opinions regarding a player's or player character's patent application for a virtual object.

The disclosed invention could be also be used for the creation of agreements between or among real or virtual end users, players, player characters or other third parties. In such cases, methods to ensure that agreements are enforceable and that advertising fees are collected in such virtual environments are desirable. Exemplary methods for providing such contract enforcement and collection of fees are disclosed, for example, in U.S. patent application Ser. No. 11/279,991 “Securing Virtual Contracts with Credit,” filed Apr. 17, 2006; Ser. No. 11/624,662 “Securing Contracts in a Virtual World,” filed Jan. 18, 2007; Ser. No. 11/559158 “Financing Options in a Virtual World” filed Nov. 13, 2006; Ser. No. 11620,542 “Satisfaction of Financial Obligations in a Virtual Environment Via Virtual and Real World Currency,” filed Jan. 5, 2007; Ser. No. 11/421,025 “Financial Institutions and Instruments in a Virtual Environment,” filed May 30, 2006, and Ser. No. 11/380,489 “Multiple Purchase Options for Virtual Purchases,” filed Apr. 27, 2006; each of which are hereby incorporated herein by reference.

In other embodiments, comments, opinions and/or notes may also be used to provide feedback regarding game play, enjoyment, features, desired features, discovered errors, and/or any other form of communication and/or ranking information.

All embodiments herein which refer to a patent are equally applicable to a patent application, and vice versa, unless explicitly stated otherwise with respect to a particular embodiment. Any reference to a patent (or to a patent application) is for reasons of brevity only.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

Exemplary programs include:
1. Document Submission and Queue Program
2. Opinion, Notes and Comment Program
3. Alert Program
4. Rating and Scoring Program
5. Survey Program
6. Search/Review Program
7. Billing/Collections Programs

Exemplary database architecture includes:

Examiner Database
1. Examiner ID
2. Name
3. Areas of practice/Fields of Use 1-N
4. Contact Information
5. Qualifications 1-N
6. Current Cases ID 1-N
7. Prior Cases ID 1-N
8. Notes 1-N
9. Rating/Score Summary
10. Rating/Score Details
   a. Rating/Score Transaction ID-1-N
   b. Notes 1-N

User Database
1. User ID
2. Name
3. Account Type
4. Description
5. Terms and Conditions ID
6. Text
7. Documents ID 1-N
8. Attorney ID 1-N
9. Notes 1-N

Attorney Database
1. Attorney ID
2. Name
3. Address
4. Description
5. Qualifications 1-N
6. Notes 1-N
7. Rating/Score Summary
8. Rating/Score Details
   a. Rating/Score Transaction ID -1-N
   b. Notes 1-N

Document Database
1. Document ID
2. Document Description
3. Document Owner ID
4. Hyperlinks (e.g., document locations) 1-N
5. Group
   a. Class 1-N
      1. Subclass 1-N
6. Type 1-N
   a. Subtype 1-N
7. Date/Time Stamps
   a. Submitted/Found/Indexed On
   b. Submitted/Found/Indexed By ID or Hyperlink
   c. Revised On 1-N
   d. Revised By 1-N
   e. Before Image 1-N
   f. After Image 1-N
8. Notes 1-N
9. Security Rules ID 1-N
10. Rating/Score Summary
11. Rating/Score Details
   a. Rating/Score Transaction ID -1-N
   b. Notes 1-N

Opinion/Note Database
1. Opinion/Note ID
2. Examiner ID
3. User ID
4. Document ID
5. Description Short
6. Description Long
7. Group ID
8. Class ID 1-N
9. Subclass ID 1-N
10. Opinion/and/or Note Attachments 1-N
11. Text
12. Related Notes ID 1-N
13. Related Documents ID 1-N
14. Security Rules ID 1-N
15. Hyperlinks 1-N
16. Change Tracking Data
   a. Modifications 1-N
   b. Submitted By ID
   c. Modification Submission Date/Time
   d. Short Description
   e. Long Description
   f. Hyperlinks 1-N
   g. Change Image 1-N
      1. Before Change
      2. After Change

Examiner Rules Database
a. Rule ID 1-N
b. Rule Description
c. Rules 1-N
2. Notes 1-N
3. Security Rules ID 1-N

Qualifications Database
1. Qualification ID
2. Description
3. Qualification Type
4. Years Experience
5. Fields of Use Applicable 1-N
6. Permissions
7. Restrictions
8. Notes 1-N

Billing Terms and Conditions Database
1. Billing Method ID
2. Billing Type
3. Description
4. Billing Frequency
5. Due by # days
6. Late by # days
7. Interest Rate Fixed
8. Interest Rate Variable
9. Interest Accrues after days
10. Notes 1-N

Accounts Receivable Database
1. Advertiser/Note Owner ID
Total Amount Owed
2. Transaction Detail Records 1-N
   a. Date of Transaction
   b. Type
   c. Advertisement ID
   d. Word ID
   e. Hyperlinks 1-N
   f. Amount per impression or click through
3. Notes 1-N

Search Database
1. Document ID
2. Document Location/Hyperlink
3. Notes 1-N

Transaction Database
1. Transaction ID
2. Description
3. Date/Time
4. Type
5. User ID
6. Examiner ID
7. Advertisement/Note Owner Rules Used 1-N
8. Billing T&C's 1-N
9. Billing Method ID
10. Transaction Amount
11. Notes 1-N
12. Results 1-N
   a. Note Added, Changed, Deleted, and/or Accessed
   b. Hyperlink Clicked
   c. Sub-Hyperlinks Clicked 1-N
      1. Advertisement/Note and/or Webpage) Displayed 1-N
      2. Click Through y/n
      3. Duration of view
      4. Conversion y/n
      5. Conversion dollar amount

Document Class Database
1. Class ID
2. Description
3. Notes 1-N

Document Sub Class Database
1. Subclass ID
2. Description
3. Notes 1-N

Document Type Database
1. Type ID
2. Description
3. Notes 1-N

Document Sub Type Database
1. Subtype ID
2. Description
3. Notes 1-N

Group Database
1. Group ID
2. Description
3. Notes 1-N

Word Count Database
1. Word ID
2. Number of Occurrences
3. Hyperlinks 1-N
4. Notes 1-N

Survey Database
1. Survey ID
2. Survey Description
3. Advertiser ID
4. Survey Question ID 1-N
   a. Question
   b. Answer Options 1-N
5. Notes 1-N

Results Database
1. Result ID
2. User ID
3. Survey Questions 1-N
4. Survey Answers 1-N
5. Date/Time Stamp
6. Narrative or Text Responses 1-N
7. Notes 1-N

Rules Database
1. Rule ID
2. Rule Description
3. Rules 1-N
4. Notes 1-N

Notes Database
1. Note ID
   a. Hyperlinks 1-N
   b. Note Description Short
   c. Note Description Long
   d. Note Group ID
   e. Note Class ID
   f. Note Subclass ID
   g. Note and/or Note Attachments 1-N
      1. Owner/Submitted By ID
      2. Original Submission Date/Time
   h. Notes 1-N
2. Modifications 1-N
   a. Owner/Submitted By ID
   b. Modification Submission Date
   c. Short Description
   d. Long Description
      1. Owner/Submitted By ID
      2. Original Submission Date/Time
      3. Hyperlinks 1-N
      4. Change Image 1-N
         a. Before Change
         b. After Change
   e. Notes 1-N

Suppression Rules Database

Hyperlink Database
1. Hyperlink ID
2. Hyperlink
3. Description
4. Owner ID
5. Advertiser ID
6. Notes 1-N

User Database
1. User ID
2. Name
3. Account Type
4. Description
5. Terms and Conditions ID
6. Text
7. Notes 1-N

Document Group Database
1. Group ID
2. Description
3. Includes Sub-Groups/Sub-Class IDs 1-N
4. Notes 1-N

Document Class
1. Class ID
2. Description
3. Includes Sub-Class IDs 1-N
4. Notes 1-N

Document Sub Class
1. Subclass ID
2. Description
3. Notes 1-N

Note Class
1. Note Class ID
2. Description
3. Includes Sub-Class IDs 1-N
4. Notes 1-N

Note Subclass
1. Note Subclass ID
2. Description
3. Notes 1-N

Alert Event Rules Database
1. Alert Event Rule ID
2. Alert Event Description
3. Alert Event Rules 1-N
   a. Event Condition
   b. Alert Recipient ID 1-N
      1. Alert Method 1-N
   c. Alert Database ID 1-N
4. Notes 1-N

Alert Database
1. Alert Database ID
2. Alert Contents, one or more of:
   a. Text
   b. Variable Data
   c. Executable
3. Notes 1-N

Alert Methods Database
1. Alert Method ID
2. Method Type
3. Delivery Method (cell phone, pager, e-mail, PDA, database, executable, etc.)
4. Notes 1-N

Alert Recipient Database
1. Alert Recipient ID (e.g., end user ID)
2. Description
3. Alert Method Preferences ID 1-N
4. Notes 1-N

Document Queue Database
1. Queue ID
2. Document IDs 1-N
   a. Queue Position Number
   b. Date Submitted
   c. Priority
   d. Notes 1-N
   e. Assigned Examiner ID 1-N

Rating/Score Transaction Database
1. Rating Transaction ID
2. Rating Type (e.g., Document, Examiner, Note, Opinion, etc.)
3. Rating/Score
4. Relevancy Score
5. Rules 1-N
6. Submitted By
   a. ID
   b. Date/Time
7. Notes 1-N

Rating/Score Rules Database
1. Rule ID
2. Description
3. Permissions
4. Limitations
5. Rules 1-N
6. Notes 1-N

Plug in Database
1. Plug-in ID
2. Short Description
3. Long Description
4. Purpose
5. Developer ID 1-N
6. Features 1-N
7. Limitations 1-N
8. Authorized Users 1-N
9. Terms and Conditions for Use 1-N
   a. Fees for Use
   b. Fee sharing rules (if any), e.g., share with USPTO
   c. Limitations on Use
   d. License/Sublicense/Modification Rights/Limitations
10. Known Errors 1-N
11. Proposed Enhancements 1-N
12. API Standard's ID 1-n
13. Date/Time Stamps
   a. Submitted On
   b. Expected Next Review Date
   c. Reviewed On-1-N
   d. Reviewed by Examiner ID 1-N
   e. Rejected/Accepted On
   f. Rejected Reasons ID 1-N
   g. Supervisor ID 1-N
   h. Notes 1-N
14. Plug-In (i.e., attachment, e.g., file and/or source and/or object code)
15. End User Or Examiner Review Notes ID 1-N
16. Notes 1-N

Change Tracking Database
1. Change Tracking ID
2. Word ID
3. Change Type (e.g., Add, change, delete)
4. Change Description
5. Date/Time
6. User ID
7. Before Image
8. After Image
9. Relevancy or score
10. Notes 1-N

Administrative Hierarchy Database
1. Hierarchy ID
2. Description
3. Supervisor ID
   a. Examiner ID 1-N
4. Related Hierarchy (i.e., higher/lower)
   a. Hierarchy ID
   b. Type (superior/inferior)

Security Rules Database
1. Security Rule ID
2. Description
3. Applications
4. Limitations
5. Security Permission Rules 1-N
6. Notes 1-N

It will be appreciated that the various software and hardware components described above will be configured to perform a variety of functions and methods. Listed below are some exemplary methods that might be performed by the systems as described herein:

Assign Document To Queue
1. Receive Document
2. Determine Appropriate Queue
3. Determine Queue Position
4. Place Document in Queue

Add Opinion
1. Receive an examiner log in
2. Generate and Output document queue
3. Receive a request to add an opinion to a document
4. Output opinion form
5. Receive opinion data
6. Store opinion data with document
7. Add Comment
8. Receive a request to add a comment to a document about an opinion
9. Generate and Output comment form
10. Receive comment data
11. Store comment data with document and opinion

Alert Users
1. Receive an indication that an addition has been made to a document record
2. Determine appropriate users
3. Alert users of addition

Score Opinion
1. Receive a request to score an opinion about a document
2. Output score form
3. Receive score
4. Store score

Score User
1. Retrieve user data
2. Generate/Receive user score based on data
3. Store user score

Score Examiner
1. Retrieve opinion data from an examiner
2. Retrieve Score data about opinions
3. Score examiner based on opinion scores

Rate User
1. Retrieve user score
2. Generate user rating based on score and rules
3. Store user rating

Rate Examiner
1. Retrieve examiner score
2. Generate examiner ratings based on score and rules
3. Store examiner rating

Or Event Driven Models:

Load Databases
1. Initially populate or create empty databases
2. Update Databases

Primary Application/Watchdog
1. Load Database(s)
2. Determine if one or more sub-applications should be executed
3. Execute appropriate sub-applications (see below)
4. Update Database(s)
5. Repeat Process as Necessary/Desired/Indicated

User Interface Application

Load database(s)

Display graphical user interface for each application/feature as requested/desired

Receive input from end users

Execute functions as requested/required and/or load additional applications/GUIs

Update databases

Security Application
1. Load Database(s)
2. Determine if requested action and/or end user is permitted
3. If not, notify application and/or end user
4. If yes, permit requested step and/or loading of application or other authorized action(s)
5. Update Database(s)

End User Preferences Application
1. Load Databases
2. Present Preferences GUI if required
3. Receive End User Preferences/Feedback/Usage Tracking Information, including:
   a. Filter Criteria or Rules
   b. Sort Criteria or Rules
   c. Relevancy Information
   d. Weighting Factors, Criteria or Rules
   e. Security Preferences
   f. Feedback/Tracking Preferences
   g. Notes
   h. Usage habits/patterns
   i. Display preferences

Opt In/Sign Up Application
1. Load Databases
2. Receiving Indication of new user sign up
3. Record any and all or available information regarding one or more patent applicant's, end users, examiners, attorneys and/or third parties
4. Update databases
5. Create/Maintain Document Database
6. Load Databases
7. Determine available or participating documents
8. Periodically search all available documents
9. Create/update index for all found (or participating) documents
10. Receive indication of add/change/delete request(s)
11. If required, queue and review request(s)
12. If required, approved or reject request(s)
13. Create/update document databases
14. Update databases

Document, Opinion, Notes Search/Indexing Program
1. Load Database(s)
2. Determine Search/Index Procedure is necessary or desired
3. Search World Wide Web or all accessible or participating databases
4. Index Documents, Opinions, Notes and Hyperlinks
5. Store Results
6. Update Database(s)

Document Submission/Filing Application
1. Load Database(s)
2. Receive request to submit document with patent applications and/or one or more words, synonyms, antonyms, figures and/or related documents to database, repository or processing agency, e.g., USPTO
3. Capture image of all relevant materials, including then current definitions, along with Time/Date stamp information
4. If desired, encrypt any or all output materials, e.g., patent application, definitions, words, synonyms, antonyms, figures and/or related documents and/or supporting materials to prevent or otherwise control subsequent access and/or modifications
5. Update Database(s)
6. End User Contest Application
7. Load Database(s)
8. Receive Indication that one or more end users and/or third parties, e.g., patent examiner, contests one or more notes, opinions and/or other documents, maps and/or supporting materials
9. Determine relevancy/validity of the contest by any one or all of the following if desired/applicable
   a. Solicit other end user/third party votes/scores/ranking
   b. Use GA
   c. Submission to authorized end user or third party
   d. Preponderance of feedback
10. If contest is determined valid, accept requested changes
11. Otherwise reject requested changes
12. Update Database(s)

Word Search/Indexing Program
1. Load Database(s)
2. Determine Search/Index Procedure is necessary or desired
3. Search World Wide Web or all accessible or participating databases / words
4. Index Words and Hyperlinks
5. Store Results
6. Update Database(s)

Opinion/Note Attachment Program
1. Load Database(s)
2. Provide Attachment Creation GUI
3. Receive New Opinion/Note from End User, e.g. Examiner
4. Create Opinion/Note
5. Create Opinion/Note Hyperlink
   a. Associate Opinion/Note with Document, e.g., patent application, Word and/or Hyperlink (as applicable), by, e.g., inserting or otherwise associating Note Hyperlink with Document, Word and/or Hyperlink
   b. Update Database(s)

Opinion/Note Modification Program
a. Load Database(s)
b. Provide Modification GUI
c. Receive Opinion/Note Change/Delete Request from End User, e.g., examiner
d. Create Opinion/Note Modification
e. If required, Create Revised Opinion/Note Hyperlink
f. Associate Revised Opinion/Note with Document, Word and/or Hyperlink, by inserting or otherwise associating Note Hyperlink with Document, Word and/or Hyperlink
g. Else, if required, delete Opinion/Note Hyperlink
h. Update Database(s)

Opinion/Note Access/Use Program
a. Load Database(s)
b. Provide Access/Use GUI
c. Receive opinion/note access/use/activation request from end user (or application), e.g., patent applicant or attorney
d. Apply Relevancy Filter (if applicable/requested/desired)
e. Determine action steps, e.g., execute program or hyperlink:
1. If applicable, perform one or more of the following:
   a. Display appropriate opinion/note contents
   b. Display like notes, opinions, documents or hyperlinks to like documents, and/or words, hyperlinks, etc.
   c. Execute program or hyperlink
   d. Display opinion, document, note and/or advertisement
   e. If desired/applicable, open new window to display opinion/note contents or advertisement and/or GUI's
   f. Execute opinion/note attachment program
f. Update Database(s)

Opinion/Note Attachment Program
a. Receive indication of new or modified or deleted opinion/note
b. Load Database(s)
c. If desired, capture before/after change images
d. Create or update or remove hyperlink(s) as required
e. Update database(s)

Find Like Opinions, Notes, Documents, Words, Hyperlinks Program
a. Load database(s)
b. Receive indication an opinion, note, document, or hyperlink has been indexed
c. Search for relevant opinions, notes, documents, or hyperlinks
d. Index results
e. Update database(s)

Opinion/Note Relevance Program
a. Load Database(s)
b. Receive Relevancy Input from End Users
c. Or use automated application to determine relevancy, e.g., via GA
d. Associate Relevancy with Opinions/Notes and/or Documents
e. Update Database(s)

Opinion/Note Search Review Program
1. Load Databases
2. Present Search GUI
3. Receive Prior Art, Opinions, Notes or Documents or other Search String Request
4. If desired, needed or requested, retrieve synonyms and display in separate search string box
5. Receive indication that end user prefers or clicks on synonym or other hyperlink
6. Determine if additional information and/or a survey is needed desired
7. If needed or desired, execute survey program
8. Determine if advertisement should be displayed
9. Display advertisement if desired, needed, requested
10. Based upon available information, e.g., search string, synonyms and/or survey results, Search any or all available and/or participating databases and/or data warehouses
11. Retrieve results including opinions, notes, prior art, other documents, synonyms, antonyms, advertisements, notes, hyperlinks, cases, and other search results data based upon any one or more of the forgoing and/or other search criteria
12. Determine weights, sort, filter and other system and/or end user search criteria of end user requesting search
13. Determine relevancy of results text/data/documents, etc. based upon any one or more criteria including:
   a. Opinion/Note Type, Group, Class or Subclass
   b. Document Type, Group, Class or Subclass
   c. User Type
   d. Security Privileges—Permissions or denials
   e. User Preferences, weighting criteria
   f. Computer Type
   g. Search Engine Type or Provider Preferences
   h. Relevancy Conditions/Information
   i. Document results section weighting
   j. Survey Questions and/or responses
   k. Past or present end user feedback
14. Determine if results data should be displayed in one or more separate page(s), popup or other window(s)
15. Display results, in whole or in part, based upon relevancy, weighting factors, document section information, and/or in sorted/filtered order and/or store results in certified or encrypted database for subsequent user or examiner or third party access, and/or other available relevancy, sorting, display options criteria
16. Display one or more of the following, in whole or in part, if indicated, requested, needed or otherwise desired including, but not limited to:
   a. Results data
   b. Opinions
   c. Notes
   d. Comments
   e. Prior art
   f. Relevancy information
   g. End user weighting, criteria, sort, filter and/or display and/or other preferences or system settings
   h. Mapping information
   i. Synonyms and/or antonyms
   j. Definitions
   k. Figures
   l. Text
   m. One or more Documents
   n. Hyperlinks
   o. Advertisements
   p. Notes
   q. Any or all other data as desired/requested/necessary
17. Update Databases

Feedback and Performance Improvement Application
1. Load Databases
2. Receive indication of end user or system activity
3. Determine if end user feedback is indicated, required, necessary offered or is otherwise submitted or provided
4. Determine feedback category, including any one or more of the following categories/items, including the relevancy, accuracy, usefulness, completeness, effectiveness or appeal of any one or more of the following system settings, and/or data including, but not limited to:
   a. Results data
   b. Opinions
   c. Notes
   d. Comments
   e. Prior art
   f. Relevancy information
   g. End user weighting, criteria, sort, filter and/or display or other preferences or system settings
   h. Mapping information
   i. Synonyms and/or antonyms
   j. Definitions
   k. Figures
   l. Text
   m. One or more Documents
   n. Hyperlinks
   o. Advertisements
   p. Ease of application or feature use
   q. Any or all other data as desired/requested/necessary
5. Request feedback and/or changes to and/or opinions regarding or relating to one or more affected end users regarding one or more feedback categories as defined/determined above and receive feedback information including at least one or more of the following, including, but not limited to:
   a. Relevancy rankings
   b. Scores
   c. Weighting factors or weights
   d. Sorting preferences
   e. Filtering preferences
   f. Display preferences
   g. Subjective criteria
   h. Notes
6. Use on screen feedback option or survey to solicit feedback
7. Receive end user feedback
8. Determine and update relevancy, weighting criteria and/or other scores
9. If feedback warrants, or so indicates, request additional feedback on the feedback
10. Modify applicable/affected criteria including, but not limited to any relevant settings such as those relating to any one or more or part or all of a/an/the:
   a. Genetic or other learning algorithms
   b. Relevancy or scoring algorithms
   c. System, end user and/or other settings, weights, preferences, sort, selection, display criteria.
   d. End user or system weighting, criteria, sort, filter and/or display and/or other preferences or system settings
   e. Mapping information
   f. Opinions
   g. Synonyms and/or antonyms
   h. Definitions
   i. Figures
   j. Text
   k. Documents
   l. Hyperlinks
   m. Advertisements
   n. Notes
   o. Any or all other data as desired/requested/necessary
11. Update databases

Usage Tracking and Optimization Program
1. Load Databases
2. Receive indication of end user or system activity
3. Store/analyze activity
4. When/if requested generate usage tracking/activity reports
5. Display reports and/or export data as requested/desired/needed
6. Determine if activity affects or is related to and/or is otherwise correlated to/with and/or could improve any results data including or system performance, including for example:
   a. Relevancy and/or scoring calculation methods or algorithms
   b. Accuracy and/or quality of opinions/notes/comments, and/or
   c. Advertising results
   d. Click through results
   e. Conversion rates
   f. End user feedback
   g. End user skills
   h. Search methods or algorithms
   i. Hyperlink use or relevancy
   j. Sort and/or filter methods, calculations and/or options
7. Provide performance data to genetic or other algorithm(s)
8. Modify methods and/or algorithms and/or end user or other options based upon performance data
9. Update Databases

Billing Program
a. Load Database(s)
b. Receive indication that billing activity has occurred
c. Determine affected parties, e.g., payer and payee
d. Determine billing rules, terms and conditions
e. Determine billing amounts due
f. Create Invoice and A/P or A/R notices/entries
g. Send Invoices and notices
h. Update Databases
i. Await Payment
j. Receive payment indication
k. Apply payments
l. Notify A/P or A/R systems/and/or affected parties
m. Determine if payments are timely/sufficient
n. If not, execute collections program
o. Update Database(s)

Collections Program
a. Receive indication payments are late and/or insufficient
b. Load Database(s)
c. If applicable, execute one or more of the following steps:
   1. Send late notice
   2. Send insufficient payment or funds notice
   3. Limit or prevent further use until payment terms are partially or fully satisfied, each according to billing terms and conditions and/or rules
   4. Collect funds due from primary and/or secondary credit cards on file.
   5. Notify affected parties
d. Update Database(s)

Mapping Program
1. Load Databases
2. Receive indication that one or more patent applications, opinions, notes, comments, words, synonyms, antonyms and/or other documents or notes have been added or changed or removed from one or more databases
3. Receive or determine relevancy information
4. Determine mapping relationships among any one or more of the forgoing
5. Monitor patent application, notes, opinions, commentary, word, synonym, antonym, and/or other documents and/or notes and/or mapping usage
6. Receive feedback from end users and/or determine change in mapping relationships and/or relevancy
7. If desired or required, submit any such changes for review/approval
8. If approved, update mapping relationship data accordingly
9. Update Databases

Survey Program
1. Load Databases
2. Receive indicator that relevancy information should be updated and/or search results may be improved with survey results data
3. And/or periodically submit one or more survey questions to one or more end users
4. Determine questions based upon survey database rules and/or based upon prior effectiveness of one or more survey questions
5. Determine respondent or target end users
6. Submit questions to respondent(s)
7. Receive results
8. Determine new relevancy scores
9. Update relevancy information and/or modify hyperlinks or advertisements based upon new or revised relevancy scores and/or other end user feedback
10. And/or use GA to determine relevancy scores and/or hyperlink and/or advertisements
11. Update databases

Alerts Program
1. Load Database(s)
2. Determine if Alert Event has occurred
3. Determine Alert Contents based upon alert rules
4. Determine Alert Recipients and Contents and Delivery Method(s)
5. Send Alert(s)
6. Update Database(s)

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing an examiner's rendered opinion regarding a patent application available to a plurality of end users via an electronic system;
receiving commentary on the examiner's opinion from at end user via the electronic system;
storing the commentary in an electronic format along with the patent application;
determining the applications the examiner has been assigned to examine that have not yet been examined and identifying these applications as being in the examiner's application queue;
altering the examiner's application queue based on the commentary.

2. The method of claim 1 wherein altering the examiner's application queue comprises adding an application to the examiner's application queue.

3. The method of claim 1 wherein altering the examiner's application queue comprises removing an application from the examiner's application queue.

4. The method of claim 1 wherein the commentary is received from a party other than the inventor, assignee, or attorney of record for the patent application.

5. The method of claim 1 wherein the commentary is received from another examiner.

6. The method of claim 1 wherein the commentary is provided in the format of a rating.

7. The method of claim 1 wherein the commentary is provided in the form of a ranking.

8. The method of claim 1 further comprising:
receiving a request from an end user to be alerted when an opinion is rendered by an examiner in a given patent application;
determining that an opinion has been rendered in the patent application; and
alerting the end user that an opinion was rendered.

9. A method comprising:
accessing an electronic database of patent applications file wrappers;
reviewing an opinion rendered by a patent examiner in an application submitted by an unrelated third party; and
submitting a review of the examiner's opinion.
